(19) United States
(12) Patent Application Publication
(10) Pub. No.: US 2024/0308123 A1
(43) Pub. Date: Sep. 19, 2024

(54) Systems and Approaches for Manufacturing Parts

(71) Applicant: IMFLUX INC., Hamilton, OH (US)

(72) Inventors: Rick Alan Pollard, Moscow, OH (US); Bryler Collins, Maineville, OH (US); Darien Rian Stancell, Cincinnati, OH (US); Brandon Michael Birchmeier, Morrow, OH (US); Gene Michael Altonen, West Chester, OH (US); William Francis Lawless, III, Medford, MA (US)

(21) Appl. No.: 18/571,144

(22) PCT Filed: Jun. 15, 2022
(86) PCT No.: PCT/US22/33551

§ 371 Date: Dec. 15, 2023

Related U.S. Application Data
(60) Provisional application No. 63/210,817, filed on Jun. 15, 2021.

(51) Int. Cl. B29C 45/77; B29C 45/76; B29C 48/92

(52) U.S. Cl. CPC B29C 45/77; B29C 45/7646; B29C 48/92; B29C 2945/76006; B29C 2945/76381; B29C 2945/76498; B29C 2945/76538; B29C 2945/76612; B29C 2948/92019; B29C 2948/92514; B29C 2948/92685; B29C 2948/92695

(57) ABSTRACT

Systems and approaches for controlling a molding machine having a mold forming a mold cavity and being controlled according to a mold cycle include injecting a molten polymer into the mold cavity. A first and a second sensor are used to obtain first measurements of respective first and second variables during the injection cycle. The second sensor is positioned downstream from the first sensor. The first and second sensors are used to obtain second measurements of the respective first and second variables during the injection cycle. A first difference value is determined between the first measurements of the first and second variables. A second difference value is determined between the second measurements of the first and second variables. The first and second difference values are compared, and at least one control parameter is adjusted based on a difference between the first and the second difference values.

### CROSS REFERENCE TO RELATED APPLICATIONS

This application claims the benefit of U.S. Provisional Application No. 63/210,817, filed on Jun. 15, 2021, the entirety of which is herein expressly incorporated by reference.

### FIELD OF THE DISCLOSURE

The present disclosure relates generally to injection molding and, more particularly, to approaches for controlling injection molding machines using startup mode mechanisms.

### BACKGROUND

Injection molding is a technology commonly used for high-volume manufacturing of parts constructed of thermoplastic materials. During repetitive injection molding processes, a thermoplastic resin, typically in the form of small pellets or beads, is introduced into an injection molding machine which melts the pellets under heat and pressure. In an injection cycle, the molten material is forcefully injected into a mold cavity having a particular desired cavity shape. The injected plastic is held under pressure in the mold cavity and is subsequently cooled and removed as a solidified part having a shape closely resembling the cavity shape of the mold. A single mold may have any number of individual cavities which can be connected to a flow channel by a gate that directs the flow of the molten resin into the cavity. A typical injection molding procedure generally includes four basic operations: (1) heating the plastic in the injection molding machine to allow the plastic to flow under pressure; (2) injecting the melted plastic into a mold cavity or cavities defined between two mold halves that have been closed; (3) allowing the plastic to cool and harden in the cavity or cavities while under pressure; and (4) opening the mold halves and ejecting the part from the mold. Upon ejecting the part from the mold, the device that injects the melted plastic into the mold cavity or cavities (e.g., a screw or an auger) enters a recovery phase in which it returns to an original position.

In these systems, a control system controls the injection molding process according to an injection cycle that defines a series of control values for the various components of the injection molding machine. For example, the injection cycle can be driven by a fixed and/or a variable melt pressure and/or screw velocity profile wherein the controller uses (for example) sensed pressures at a nozzle and/or screw velocity as the input for determining a driving force applied to the material.

Increasing environmental awareness has resulted in an increased use of sustainable manufacturing process. For example, post-consumer regrind or recycled plastic materials are increasingly used as a material for forming molded parts. At times, this material may be sourced from different product lots which may not be properly sorted, and as such, subsequent batches of plastic may have different material properties. Additionally, even if the products are properly sorted prior to being reused in manufacturing, it is likely that each individual container within a particular lot may have different viscosity and density properties. As a result, the molten polymeric material obtained from the reused containers that is used to form parts may not have uniform material properties such as viscosity and/or density.

Further still, it is possible that when injection molding with regrind material, the material properties such as viscosity and/or density may vary during a single injection cycle. When viscosity of the molten plastic material changes, quality of the molded part may be impacted. For example, if the viscosity of the molten plastic material increases, the molded part may be “under-packed” or less dense, due to a higher required pressure, after filling, to achieve optimal part quality. Conversely, if the viscosity of the molten plastic material decreases, the molded part may experience flashing as the thinner molten plastic material is pressed into the seam of the mold cavity. Furthermore, recycled plastic material that is mixed with virgin material may impact the melt flow index (MFI) of the combined plastic material. Inconsistent mixing of the two materials may also create MFI variation between cycles.

Some conventional injection molding machines do not adjust the molding cycle to account for changes in viscosity, MFI, or other material properties. As a result, these injection molding machines may produce lower quality parts, which must be removed during quality-control inspections, thereby leading to operational inefficiencies. Moreover, as an injection molding run may include hundreds, if not thousands, of mold cycles, the characteristics of the molten plastic material are not constant across each mold cycle of the run. Thus, even if the mold cycle is adapted to account for changes in material properties at the onset of the run, the changing properties may still result in the production of lower quality parts during mold cycles executed later in the run.

### SUMMARY

Embodiments within the scope of the present invention are directed to the control of injection molding machines to produce repeatably consistent parts. Systems and approaches for controlling a molding machine having a mold forming a mold cavity and being controlled according to a mold cycle include injecting a molten polymer into the mold cavity. A first and a second sensor are used to obtain first measurements of respective first and second variables during the injection cycle. The second sensor is positioned downstream from the first sensor. The first and second sensors are used to obtain second measurements of the respective first and second variables during the injection cycle. A first difference value is determined between the first measurements of the first and second variables. A second difference value is determined between the second measurements of the first and second variables. The first and second difference values are compared, and at least one control parameter is adjusted based on a difference between the first and the second difference values.

In some approaches, the step of adjusting at least one control parameter includes adjusting a pressure value. In these and other examples, a plurality of melt pressure transducers are used to obtain the first and second measurements of the first and second variables. Further, in some examples, the plurality of melt pressure transducers are positioned at a location defining a known volume.

In some examples, the difference between the first and the second difference values represents a change in at least one of a viscosity or a density of the molten polymer during the injection cycle.

In accordance with a second aspect, a molding machine includes a molding unit, a controller, a first sensor, and a second sensor. The injection unit includes a mold forming a mold cavity and a screw that moves from a first position to a second position. The injection unit receives and injects a molten plastic material into the mold cavity via the screw to form a molded part. The controller controls operation of the injection molding machine according to a molding cycle. The first sensor is coupled with the injection molding machine and the controller and measures a first variable during the injection cycle. The second sensor is also coupled with the injection molding machine and the controller and measures a second variable during the injection cycle. A relative position between the first and second sensors defines a known volume. The controller commences injection of the molten polymer into the mold cavity and determines a first difference value between a first variable measurement obtained by the first sensor and a first variable measurement obtained by the second sensor. Further, the controller determines a second difference value between a second variable measurement subsequently obtained by the first sensor and a second variable measurement subsequently obtained by the second sensor and compares the first difference value with the second difference value. The controller then adjusts at least one control parameter based on a difference between the first and the second difference values.

In accordance with a third aspect, an approach for forming a part according to a cycle includes introducing a molten polymer into a cavity and obtaining, using a first sensor, a first measurement of a first variable and a subsequent second measurement of the first variable during the cycle. Further, the approach includes obtaining, using a second sensor positioned downstream of the first sensor, a first measurement of a second variable and a subsequent second measurement of the second variable during the cycle. A change in pressure of the molten polymer is sensed based on at least two of the first measurement of the first variable, the second measurement of the first variable, the first measurement of the second variable, or the second measurement of the second variable. At least one control parameter is adjusted based on the change in pressure of the molten polymer.

In accordance with a fourth aspect, an approach for controlling an extrusion molding machine having a die forming a molded parison and being controlled according to an extrusion cycle include extruding a molten polymer through an extrusion die. A first and a second sensor are used to obtain first measurements of respective first and second variables during the extrusion cycle. The second sensor is positioned downstream from the first sensor. The first and second sensors are used to obtain second measurements of the respective first and second variables during the extrusion cycle. A first difference value is determined between the first measurements of the first and second variables. A second difference value is determined between the second measurements of the first and second variables. The first and second difference values are compared, and at least one control parameter is adjusted based on a difference between the first and the second difference values

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale. For example, the dimensions and/or relative positioning of some of the elements in the figures may be exaggerated relative to other elements to help to improve understanding of various embodiments of the present invention.

FIG. 1 illustrates a schematic view of an example injection molding machine having a controller coupled therewith in accordance with various embodiments of the present disclosure;

FIG. 2 illustrates a portion of the example injection molding machine of FIG. 1 having an example sensor unit in accordance with various embodiments of the present disclosure;

FIG. 3 illustrates a top plan view of an example nozzle adapter for use with the example sensor unit of FIGS. 1 and 2 in accordance with various embodiments of the present disclosure;

FIG. 4 illustrates a side elevation cross-sectional view of the example nozzle adapter of FIG. 3 having a plurality of sensors installed therein in accordance with various embodiments of the present disclosure;

FIG. 5 illustrates a front elevation view of the example nozzle adapter of FIGS. 3 and 4 in accordance with various embodiments of the present disclosure;

FIG. 6 illustrates a perspective view of an alternative example nozzle adapter in accordance with various embodiments of the present disclosure;

FIG. 7 illustrates a side elevation cross-sectional view of the example nozzle adapter of FIG. 6 in accordance with various embodiments of the present disclosure.

### DETAILED DESCRIPTION

Generally speaking, aspects of the present disclosure include systems and approaches for controlling a molding machine (e.g., an injection molding machine and/or an extrusion molding machine) where a number of sensors are positioned inline and upstream from the mold cavity to sense changes to the rheology of the molten polymer. The sensors are positioned a known distance apart from each other, and are arranged such that a reduction in pressure is generated therebetween. By calculating the interior volume and the known pressure drop, the systems and approaches described herein may determine a change in viscosity and/or density of the molten material in real time. This information may be used to make real-time adjustments of melt pressure setpoints.

The systems and approaches described herein use an injection molding machine that operates at a substantially constant melt pressure value as compared with conventional systems which include a steep ramp-up of melt pressure until a peak pressure value is obtained, followed by a decline in pressure until the injection cycle is completed. Such operation at substantially constant pressure values advantageously eliminates a need to dynamically perform calculations based on sensor measurements due to changing pressure values.

In some examples (and as will be described herein), the injection molding machine may incorporate a single sensor, two sensors, or more than two sensors used to calculate changes in viscosity and/or density in real-time.

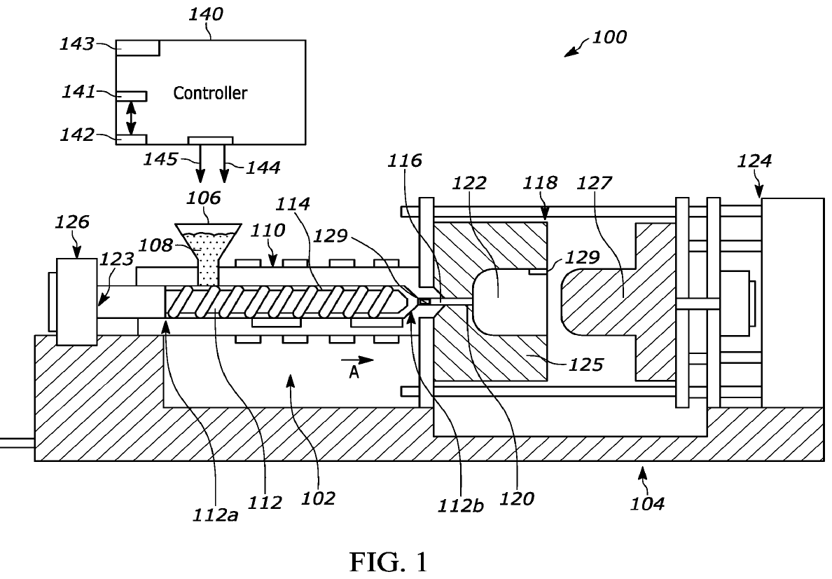

Turning to the drawings, an injection molding process is herein described. The approaches described herein may be suitable for electric presses, servo-hydraulic presses, hydraulic presses, and other known machines. As illustrated in FIGS. 1 & 2, the injection molding machine 100 includes an injection unit 102 and a clamping system 104. The injection unit 102 includes a hopper 106 adapted to accept material in the form of pellets 108 or any other suitable form. In many of these examples, the pellets 108 may be a polymer or polymer-based material such as, for example, post-consumer regrind (PCR). Other examples are possible.

The hopper 106 feeds the pellets 108 into a heated barrel 110 of the injection unit 102. Upon being fed into the heated barrel 110, the pellets 108 may be driven to the end of the heated barrel 110 towards a barrel end cap 110a by a reciprocating screw 112 that is movable from a first, original position 112a to a number of subsequent positions for inject the first, second, third, and/or any subsequent shots. The heating of the heated barrel 110 and the compression of the pellets 108 by the reciprocating screw 112 causes the pellets 108 to melt, thereby forming a molten plastic material or polymer 114. The molten plastic material 114 is typically processed at a temperature selected within a range of about 130° C. to about 410° C. (with manufacturers of particular polymers typically providing injection molders with recommended temperature ranges for given materials).

The reciprocating screw 112 advances forward from a first position 112a to a second position 112b and forces the molten plastic material 114 toward a nozzle 116 to form a shot of plastic material that will ultimately be injected into a mold cavity 122 of a mold 118 via one or more gates 120 which direct the flow of the molten plastic material 114 to the mold cavity 122. In other words, the reciprocating screw 112 is driven to exert a force on the molten plastic material 114. In other embodiments, the nozzle 116 may be separated from one or more gates 120 by a feed system (not illustrated). The mold cavity 122 is formed between the first and second mold sides 125, 127 of the mold 118 and the first and second mold sides 125, 127 are held together under pressure via a press or clamping unit 124.

The press or clamping unit 124 applies a predetermined clamping force during the molding process which is greater than the force exerted by the injection pressure acting to separate the two mold halves 125, 127, thereby holding together the first and second mold sides 125, 127 while the molten plastic material 114 is injected into the mold cavity 122. To support these clamping forces, the clamping system 104 may include a mold frame and a mold base, in addition to any other number of components, such as a tie bar.

In some examples, once the shot of molten plastic material 114 is injected into the mold cavity 122, the reciprocating screw 112 halts forward movement. The molten plastic material 114 takes the form of the mold cavity 122 and cools inside the mold 118 until the plastic material 114 solidifies. Upon solidifying, the press 124 releases the first and second mold sides 115, 117, which are then separated from one another. The finished part may then be ejected from the mold 118. The mold 118 may include any number of mold cavities 122 to increase overall production rates. The shapes and/or designs of the cavities may be identical, similar to, and/or different from each other. For instance, a family mold may include cavities of related component parts intended to mate or otherwise operate with one another. In some forms, an “injection cycle” is defined as of the steps and functions performed between commencement of injection and ejection. Upon completion of the injection cycle, a recovery profile is commenced during which the reciprocating screw 112 returns to the first position 112a.

The injection molding machine 100 also includes a controller 140 communicatively coupled with the machine 100 via connection 145. The connection 145 may be any type of wired and/or wireless communications protocol adapted to transmit and/or receive electronic signals. In these examples, the controller 140 is in signal communication with at least one sensor, such as, for example, sensors 130, 132 disposed within or otherwise coupled with sensor unit 128 located in or near the nozzle 116 and/or a sensor unit 129 located in or near the mold cavity 122. In some examples, the sensor unit 128 is located at a leading end of the screw 112 and is in the form of a nozzle adapter, while the sensor unit 129 is located in a manifold or a runner of the injection machine 100. Alternatively, the sensor unit 128 may be located at any position ahead of the check ring of the screw 112. It is understood that any number of additional real and/or virtual sensors capable of sensing any number of characteristics of the mold 118 and/or the machine 100 may be used and placed at desired locations of the machine 100.

The controller 140 can be disposed in a number of positions with respect to the injection molding machine 100. As examples, the controller 140 can be integral with the machine 100, contained in an enclosure that is mounted on the machine, contained in a separate enclosure that is positioned adjacent or proximate to the machine, or can be positioned remote from the machine. In some embodiments, the controller 140 can partially or fully control functions of the machine via wired and/or wired signal communications as known and/or commonly used in the art.

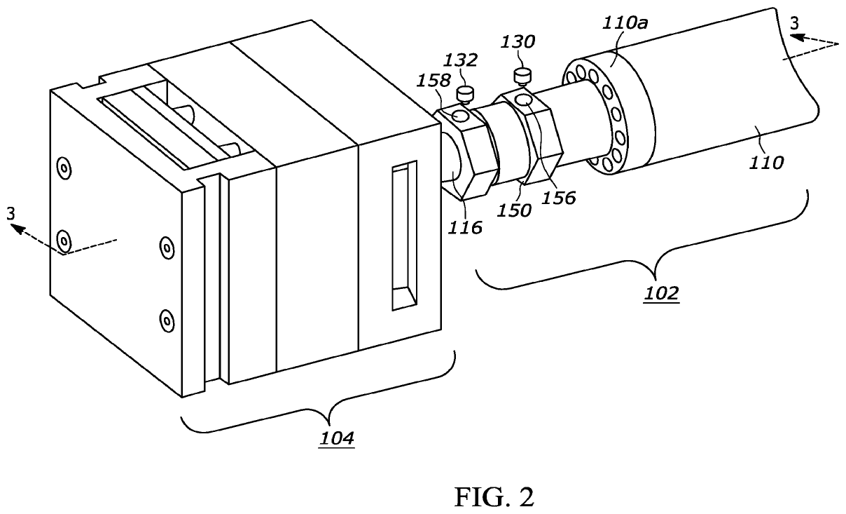

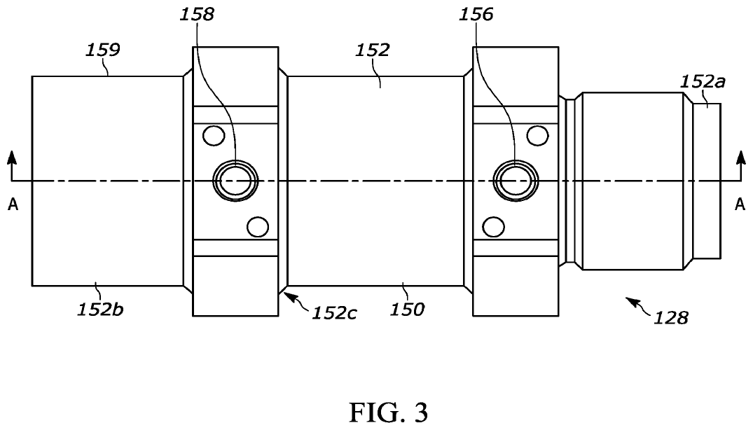

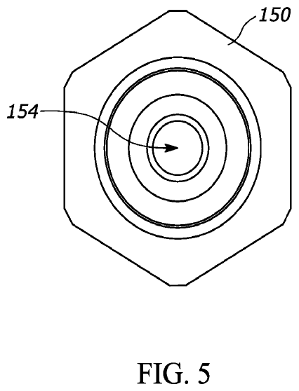

With reference to FIGS. 2-5, the sensor unit 128 includes a nozzle adapter 150 adapted to receive the first and second sensors 130, 132. In some examples, the sensor unit 128 may also include an encapsulation assembly (not illustrated) having an encapsulation shroud (not illustrated). The nozzle adapter 150 is adapted to be coupled with the nozzle 116 in operation of the machine 100 and defines a body 152 having a first end 152a, a second end 152b, and a longitudinal length 152c extending between the first and second ends 152a, 152b. Further, the nozzle adapter 150 has a channel 154 defining a flow path 155 that extends between the first and second ends 152a, 152b to allow for molten plastic material 114 to flow therethrough in order to enter into the mold cavity 122.

The nozzle adapter 150 further includes a first nozzle port or through bore 156 and a second nozzle port or through bore 158 formed in the body 152. Each of the nozzle ports 156, 158 extends into the flow path 155. The nozzle adapter 150 additionally includes at least one mounting portion 159. In the illustrated example, the nozzle body 152 is generally cylindrical in shape. Other examples of suitable shapes and or configurations of the nozzle adapter 150 are possible.

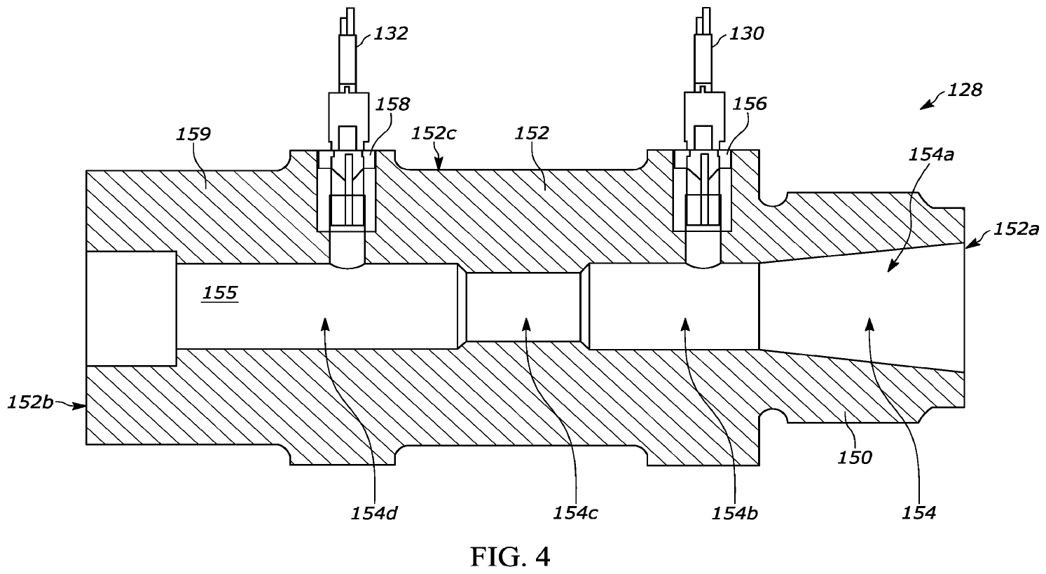

In some approaches, installing the nozzle adapter 150 may include coupling the nozzle adapter 150 with the nozzle 116 using any number of approaches. For example, the nozzle adapter 150 may threadably and/or frictionally engage the nozzle 116. In these examples, the flow path 155 of the nozzle adapter 151 may be collinear with the flow path of the nozzle 116. As illustrated in FIG. 4, the sensors 130, 132 are inserted into respective nozzle ports 156, 158, which may be threaded so as to require the sensors 130, 132 to be threadably inserted therein.

As also illustrated in FIG. 4, the channel 154 of the nozzle adapter 150 has a varying cross-sectional geometry. More specifically, at the first end 152a of the body 152, the channel 154 has a generally conical section 154a that transitions to a first cylindrical section 154b. The first nozzle port 156 is positioned at this first cylindrical section 154b such that the first sensor 130 may sense a flow characteristic along a generally constant cross-sectional volume. A second cylindrical section 154c is positioned downstream from the first cylindrical section 154b. The second cylindrical section 154c has a smaller cross-sectional diameter than the first cylindrical section 154b, and may include a gradual reduction in diameter.

A third cylindrical section 154d is positioned downstream from the second cylindrical section 154c. The second nozzle port 158 is positioned at this third cylindrical section 154d such that the second sensor 132 may sense a flow characteristic along a generally constant cross-sectional volume. Notably, the third cylindrical section 154d has a larger cross-sectional diameter than the second cylindrical section 154c, and may include a gradual increase in diameter. In some examples, the third cylindrical section 154d may have a similar or identical cross-sectional diameter as the first cylindrical section 154b. in other examples, the diameters of the first and third cylindrical sections 154b, 154d may be different. In any event, the reduction and subsequent increase in cross-sectional diameter of the channel 154 generates a pressure drop within the flow path 155 having a known or readily identifiable value.

In these examples, the nozzle ports 156, 158, and thus the sensors 130, 132 are positioned a known distance apart from each other such as, for example, approximately five inches. Accordingly a known volume separates the two sensors 130, 132, and the second sensor 132 is positioned downstream from the first sensor 130.

The sensors 130, 132 may be any type of sensor adapted to measure (either directly or indirectly) one or more characteristics of the molten plastic material 114 and/or portions of the machine 100. The sensors 130, 132 may measure any characteristics of the molten plastic material 114 that are known and used in the art, such as, for example, a pressure value, temperature, flow rate, hardness, strain, compressibility, viscoelasticity, or any one or more of any number of additional characteristics which are indicative of these. The sensors 130, 132 may or may not be in direct contact with the molten plastic material 114. In some examples, the sensors 130, 132 may be adapted to measure any number of characteristics of the injection molding machine 100 and not just those characteristics pertaining to the molten plastic material 114. As an example, the sensors 130, 132 may be pressure transducers that measure a melt pressure (during the injection cycle) and/or a back pressure (during the extrusion profile and/or recovery profile) of the molten plastic material 114 at the nozzle 116.

Each of the sensors 130, 132 generates a signal which is transmitted to an input of the controller 140. The controller 140 may receive these measurements and may translate the measurements to other characteristics of the molten plastic material 114, such as a viscosity value.

Similarly, the sensors disposed within or operably coupled with the sensor unit 129 may be any type of sensor adapted to measure (either directly or indirectly) one or more characteristics of the molten plastic material 114 to detect its presence and/or condition in the mold cavity 122. In various embodiments, the sensor unit 129 may be located at or near an end-of-fill position in the mold cavity 122. The sensor unit 129 may measure any number of characteristics of the molten plastic material 114 and/or the mold cavity 122 that are known in the art, such as pressure, temperature, viscosity, flow rate, hardness, strain, optical characteristics such as translucency, color, light refraction, and/or light reflection, and the like, or any one or more of any number of additional characteristics indicative of these. The sensor unit 129 may or may not be in direct contact with the molten plastic material 114. As an example, the sensor unit 129 may be a pressure transducer that measures a cavity pressure of the molten plastic material 114 within the cavity 122. In yet other examples, the sensor unit 128 may be a count sensor that measures the number of shots or times the reciprocating screw 112 has advanced. The sensor unit 129 generates a signal which is transmitted to an input of the controller 140. Any number of additional sensors may be used to sense and/or measure operating parameters.

In some examples, an additional upstream sensor 123 may be provided. In such examples, the upstream sensor 123 may be in the form of a machine load cell and/or a hydraulic pressure sensor. The upstream sensor 123 may be located behind the reciprocating screw 112. Like the previously-described sensors 130, 132 and sensor unit 129, the upstream sensor 123 may generate a signal which is transmitted to an input of the controller 140. The controller 140 may receive these measurements and may translate the measurements to other characteristics of the screw as a way to interpret material conditions of the molten plastic material 114.

The controller 140 is also in signal communication with a screw control 126. In some embodiments, the controller 140 generates a signal which is transmitted from an output of the controller 140 to the screw control 126. The controller 140 can control any number of characteristics of the machine, such as injection pressures (by controlling the screw control 126 to advance the screw 112 at a rate which maintains a desired value corresponding to the molten plastic material 114 in the nozzle 116), barrel temperatures, clamp closing and/or opening speeds, cooling time, inject forward time, overall cycle time, pressure set points, ejection time, screw recovery speed, back pressure values exerted on the screw 112, and screw velocity.

The signal or signals from the controller 140 may generally be used to control operation of the molding process such that variations in material viscosity, mold temperatures, melt temperatures, and other variations influencing filling rate are taken into account by the controller 140. Alternatively or additionally, the controller 140 may make necessary adjustments in order to control for material characteristics such as volume and/or viscosity. Adjustments may be made by the controller 140 in real time or in near-real time (that is, with a minimal delay between sensors 123, 129, 130, and/or 132 sensing values and changes being made to the process), or corrections can be made in subsequent cycles. Furthermore, several signals derived from any number of individual cycles may be used as a basis for making adjustments to the molding process. The controller 140 may be connected to the sensors 123, 129, 130, and/or 132, the screw control 126, and or any other components in the machine 100 via any type of signal communication approach.

The controller 140 includes software 141 adapted to control its operation, any number of hardware elements 142 (such as, for example, a non-transitory memory module and/or processors), any number of inputs 143, any number of outputs 144, and any number of connections 145. The software 141 may be loaded directly onto a non-transitory memory module of the controller 140 in the form of a non-transitory computer readable medium, or may alternatively be located remotely from the controller 140 and be in communication with the controller 140 via any number of controlling approaches. The software 141 includes logic, commands, and/or executable program instructions which may contain logic and/or commands for controlling the injection molding machine 100 according to a mold cycle. The software 141 may or may not include an operating system, an operating environment, an application environment, and/or a user interface.

The hardware 142 uses the inputs 143 to receive signals, data, and information from the injection molding machine being controlled by the controller 140. The hardware 142 uses the outputs 144 to send signals, data, and/or other information to the injection molding machine. The connection 145 represents a pathway through which signals, data, and information can be transmitted between the controller 140 and its injection molding machine 100. In various embodiments this pathway may be a physical connection or a non-physical communication link that works analogous to a physical connection, direct or indirect, configured in any way described herein or known in the art. In various embodiments, the controller 140 can be configured in any additional or alternate way known in the art.

The connection 145 represents a pathway through which signals, data, and information can be transmitted between the controller 140 and the injection molding machine 100. In various embodiments, these pathways may be physical connections or non-physical communication links that work analogously to either direct or indirect physical connections configured in any way described herein or known in the art. In various embodiments, the controller 140 can be configured in any additional or alternate way known in the art.

As previously noted, the restriction formed in the channel 154 (i.e., the second cylindrical section 154c) causes the molten plastic material 114 to experience a known drop in pressure as it flows therethrough. Due to the channel 154 having a known volume between the sensors 130, 132, and the injection molding machine 100 operating at a substantially constant pressure, the sensors 130, 132 may measure, in real time, melt pressures of the molten plastic material 114 and may determine whether a change in sensed melt pressure values has occurred over time. In these examples, it is expected that due to the geometry of the channel 154, the pressure measurements obtained by the first and second sensors 130, 132 will be different from each other. However, if the sensors 130, 132 sense different pressure values in subsequent measurements, such readings may be indicative of a change in material properties of the molten plastic material 114 (e.g., a change in viscosity and/or density).

During the injection cycle, the controller 140 monitors the sensed values from the first and second sensors 130, 132. More specifically, upon commencing the injection molding cycle and when the molten plastic material 114 passes by the bores 156, 158 accommodating the respective sensors, 130, 132, the controller 140 obtains an initial, baseline measurement (e.g., respective pressure values) sensed by each of the first and second sensors 130, 132. In some examples, the baseline measurement may be obtained at other times, such as, for example, during any cycle that produces a satisfactory part. In these examples, the operator may identify which cycle produced a satisfactory part, and the controller 140 may obtain measurements from the designated cycle. The first sensor 130 may obtain a first measurement of a first variable (e.g., a first adapter pressure), and the second sensor 132 may obtain a first measurement of a second variable (e.g., a second adapter pressure). These measurements may be saved on the memory module of the controller 140.

At a subsequent time (e.g., at any desired interval, or in some examples, continuously), the sensors 130, 132 obtain second measurements of respective first and second variables during the injection cycle. The controller 140 may then take the obtained measurements and determine a first difference value between the first measurements (i.e., the first measurement of the first adapter pressure and the first measurement of the second adapter pressure) as well as a second difference value between the second measurements (i.e., the second measurement of the first adapter pressure and the second measurement of the second adapter pressure). The first and second difference values are then compared by the controller 140 to determine if there is a relative change between the baseline and later-obtained measurements. In the event that there is no change between the baseline and later-obtained measurements, the controller takes no action, as such a comparative value would indicate that the material characteristics are unchanged. However, if there is a change between the baseline and later-obtained measurements, the controller may then modify at least one operational parameter such as, for example, a melt pressure setpoint, a screw recovery profile, an end of fill response and/or other corrective actions such as sending the molten plastic material 114 to be further processed or blended.

Such as system allows an operator and/or the machine to calculate the true viscosity and/or density changes to the molten plastic in real time, and may use this information in a feedback loop to appropriately adjust the system. Such changes may be made on an intra cycle basis and/or an inter cycle basis. Further, material data may be stored in real time for the purpose of sending material quality data points to processing facilities to assist with maintaining appropriate PCR regrind quality. Historical data may also be collected and stored for process quality control.

The below Table 1 exemplifies how the different changes to subsequent measurements obtained by the first sensor 130 (“Sensor 1”) and the second sensor 132 (“Sensor 2”) and can provide an explanation of whether the molten plastic material 114 has exhibited a change in density and/or viscosity.

TABLE 1

| Sensor 1 | Sensor 2 | Viscosity Indication |
|---|---|---|
| Baseline (0) | Baseline (0) | No Change |
| Same | Same | No Change |
| Same | Increase | Decrease |
| Same | Decrease | Increase |
| Increase | Same | Increase |
| Decrease | Same | Decrease |
| Increase | Increase | No Change |
| Increase | Decrease | Increase |
| Decrease | Increase | Decrease |
| Decrease | Decrease | No Change |

In some examples, the controller 140 may additionally rely on sensor information obtained from the upstream sensor 123. In these examples, the machine load cell or hydraulic sensor 123 may also provide comparative data between a baseline value and later-obtained value. The following Table 2 exemplifies how the different changes to subsequent measurements obtained by the upstream sensor 123 (“Sensor unit 1”), the first sensor 130 (“Sensor 2”), and the second sensor 132 (“Sensor 3”) and can provide an explanation of whether the molten plastic material 114 has exhibited a change in density and/or viscosity.

TABLE 2

| Sensor unit 1 | Sensor 2 | Sensor 3 | Viscosity Indication |
|---|---|---|---|
| Baseline (0) | Baseline (0) | Baseline (0) | No Change |
| Increase | Same | Same | No Change |
| Decrease | Same | Same | No Change |
| Same | Increase | Same | N/A |
| Same | Decrease | Same | N/A |
| Same | Same | Increase | Decrease |
| Same | Same | Decrease | Increase |
| Increase | Increase | Same | Increase |
| Increase | Decrease | Same | N/A |
| Decrease | Increase | Same | N/A |
| Decrease | Decrease | Same | Decrease |
| Increase | Same | Increase | N/A |
| Increase | Same | Decrease | Increase |
| Decrease | Same | Increase | Decrease |
| Decrease | Same | Decrease | N/A |
| Same | Increase | Increase | No Change |
| Same | Increase | Decrease | N/A |
| Same | Decrease | Increase | N/A |
| Same | Decrease | Decrease | No Change |

By incorporating the approaches described herein, the machine 100 may safely operate in an efficient manner while ensuring parts are produced having minimal defects and/or flaws by making adjustments to ensure the density and/or viscosity of the material remains constant. Additionally, in some environments, the real-time rheology measurements described herein may result in time savings while consistently producing high-quality parts. The in-line rheology processes described herein may advantageously be incorporated into conventional injection molding systems, injection molding systems incorporating low, substantially constant pressure approaches, injection molding systems incorporating specialized control based on real-time viscosity measurements, extrusion molding systems, and any other systems.

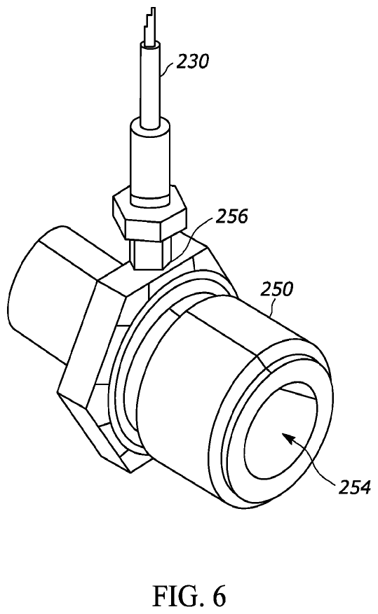

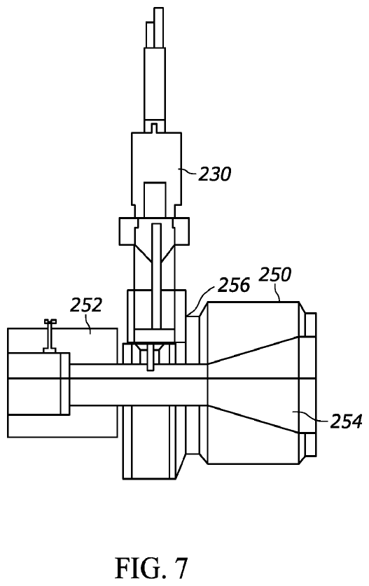

It is appreciated that a number of alternative features may be incorporated into the system 100. For example, with reference to FIGS. 6 and 7, an alternative nozzle adapter 250 is provided. The nozzle adapter 250 includes a single through bore 156 to receive a single sensor 230 (e.g., a melt pressure transducer). The sensor 230 may be capable of detecting both upstream and downstream pressure values by utilizing the hydraulic pressure or loadcell measurement provided by the machine.

In some examples (not illustrated) additional sensors may be positioned in adapters having pressure drop-generating geometries. In such an example, each sensor may be used to compile a full shear curve of the molten polymer material. Further, it will be appreciated that the systems and approaches described herein may be applied to an extrusion molding apparatus. In such an apparatus, a mold cavity is not provided and rather, extrusion molding components may be incorporated into the system. The above-described approaches may be used in conjunction with any injection process where the previously-identified pattern is used to drive at least a portion of the injection cycle. These approaches may be used in the formation of any number of different molded parts constructed from a variety of materials such as, for example silicone and metal parts.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

1. A method for controlling a molding machine having a mold forming a mold cavity, the injection molding machine being controlled by a controller according to a mold cycle, the method comprising:
injecting a molten polymer into the mold cavity;
obtaining, using a first sensor, a first measurement of a first variable during the injection cycle;
obtaining, using a second sensor positioned downstream of the first sensor, a first measurement of a second variable during the injection cycle;
obtaining, using the first sensor, a second measurement of the first variable during the injection cycle;
obtaining, using the second sensor, a second measurement of the second variable during the injection cycle;
determining a first difference value between the first measurement of the first variable and the first measurement of the second variable;
determining a second difference value between the second measurement of the first variable and the second measurement of the second variable;
comparing the first difference value with the second difference value; and
adjusting at least one control parameter based on a difference between the first and the second difference values.

2. The method of claim 1, wherein the step of adjusting at least one control parameter comprises adjusting a pressure value.

3. The method of claim 1, wherein a plurality of melt pressure transducers are used to obtain the first and the second measurements of the first and the second variables.

4. The method of claim 3, wherein the plurality of melt pressure transducers are positioned at a location defining a known volume.

5. The method of claim 1, wherein the difference between the first and the second difference values represents a change in at least one of a viscosity or a density of the molten polymer during the injection cycle.

6. A molding machine comprising:
a molding unit having a mold forming a mold cavity and a screw that moves from a first position to a second position, the injection unit adapted to receive and inject a molten plastic material into the mold cavity via the screw to form a molded part;
a controller adapted to control operation of the injection molding machine according to a molding cycle;
a first sensor coupled with the injection molding machine and the controller, the sensor adapted to measure a variable during the injection cycle;
a second sensor coupled with the injection molding machine and the controller, the sensor adapted to measure a second variable during the injection cycle, wherein a relative position between the first sensor and the second sensor defines a known volume;
wherein the controller is adapted to:
commence injection of the molten polymer into the mold cavity,
determine a first difference value between a first variable measurement obtained by the first sensor and a first variable measurement obtained by the second sensor,
determine a second difference value between a second variable measurement subsequently obtained by the first sensor and a second variable measurement subsequently obtained by the second sensor,
compare the first difference value with the second difference value, and
adjust at least one control parameter based on a difference between the first and the second difference values.

7. The molding machine of claim 6, wherein the at least one control parameter includes a pressure value.

8. The molding machine of claim 6, wherein each of the first and the second sensors comprises a melt pressure transducer.

9. The molding machine of claim 6, wherein the difference between the first and the second difference values represents a change in at least one of a viscosity or a density of the molten polymer during the injection cycle.

10. A method for forming a part according to a cycle, the method comprising:
introducing a molten polymer into a cavity;
obtaining, using a first sensor, a first measurement of a first variable and a subsequent second measurement of the first variable during the cycle;
obtaining, using a second sensor positioned downstream of the first sensor, a first measurement of a second variable and a subsequent second measurement of the second variable during the cycle;
sensing, based on at least two of the first measurement of the first variable, the second measurement of the first variable, the first measurement of the second variable, or the second measurement of the second variable, a change in pressure of the molten polymer; and
adjusting at least one control parameter based on the change in pressure of the molten polymer.

11. The method of claim 10, wherein the sensed change in pressure of the molten polymer is indicative of a change in at least one of a viscosity or a density of the molten polymer.

12. The method of claim 10, wherein the step of sensing a change in pressure includes sensing a difference between the first measurement of the first variable and the second measurement of the first variable.

13. The method of claim 10, wherein the step of sensing a change in pressure includes:
sensing a difference between the first measurement of the first variable and the second measurement of the first variable; and
sensing a difference between the first measurement of the second variable and the second measurement of the second variable.

14. The method of claim 10, wherein the step of sensing a change in pressure includes sensing a difference between the first measurement of the second variable and the second measurement of the second variable.

15. The method of claim 10, wherein the molten polymer is introduced into a cavity of a molding machine.

16. The method of claim 10, wherein the molten polymer is introduced into a die of an extrusion machine.

17. A method for controlling an extrusion molding machine having a die forming a molded parison, the extrusion machine being controlled by a controller according to an extrusion cycle, the method comprising:
extruding a molten polymer through an extrusion die;
obtaining, using a first sensor, a first measurement of a first variable during the extrusion cycle;
obtaining, using a second sensor positioned downstream of the first sensor, a first measurement of a second variable during the extrusion cycle;
obtaining, using the first sensor, a second measurement of the first variable during the extrusion cycle;
obtaining, using the second sensor, a second measurement of the second variable during the extrusion cycle;
determining a first difference value between the first measurement of the first variable and the first measurement of the second variable;
determining a second difference value between the second measurement of the first variable and the second measurement of the second variable;
comparing the first difference value with the second difference value; and
adjusting at least one control parameter based on a difference between the first and the second difference values.

18. The method of claim 17, wherein the step of adjusting at least one control parameter comprises adjusting a pressure value.

19. The method of claim 17, wherein a plurality of melt pressure transducers are used to obtain the first and the second measurements of the first and the second variables.

20. The method of claim 19, wherein the plurality of melt pressure transducers are positioned at a location defining a known volume.

21. The method of claim 17, wherein the difference between the first and the second difference values represents a change in at least one of a viscosity or a density of the molten polymer during the extrusion cycle.
